(19) United States
(12) Patent Application Publication
(10) Pub. No.: US 2025/0123870 A1
(43) Pub. Date: Apr. 17, 2025

(54) RESOURCE USAGE MANAGEMENT FOR INTEGRATION FLOWS IN A CLOUD ENVIRONMENT

(71) Applicant: SAP SE, Walldorf (DE)

(72) Inventors: Markus Muenkel, Reilingen (DE); Mitko Kolev, Walldorf (DE); Syed Muhammad Kumail Raza, Heidelberg (DE); Sebastian Helmling, Weingarten (DE); Stefan Opderbeck, Walldorf (DE); Venkata Narayana Papineni, Ostringen (DE)

(21) Appl. No.: 18/487,564

(22) Filed: Oct. 16, 2023

(51) Int. Cl. G06F 9/455

(52) U.S. Cl. CPC G06F 9/45558; G06F 2009/45591

(57) ABSTRACT

Various examples are directed to systems and methods of managing and integration platform. A cloud environment may execute an integration runtime that runs a plurality of integration flows, a first integration flow of the plurality of integration flows may be configured to interface at least one message between a first software component and a second software component. The cloud environment may also execute at least one agent associated with the integration runtime, the at least one agent being programmed to monitor usage of a first cloud environment resource by at least one integration flow of the plurality of integration flows. The cloud environment may also execute an integration inspect service to receive, from the at least one agent, resource usage data describing use of the first cloud environment resource by the first integration flow.

### BACKGROUND

An integration platform is a software application or set of software applications that is configured to integrate messaging between sets of different software applications. For example, an integration platform may receive messages sent by one software application, referred to as a sender component, and route the messages to another software application, referred to as a receiver component. The integration platform may perform various transformations on the messages from the sender component so that the messages may be successfully read and processed by the receiver component. In some examples, the integration platform is configured to poll the sending component to retrieve messages that are to be sent to the receiver component.

### BRIEF DESCRIPTION OF DRAWINGS

The present disclosure is illustrated by way of example and not limitation in the following figures.

FIG. 1 is a diagram showing one example of an environment managing resource usage by integration flows in a cloud environment.

FIG. 2 is a diagram showing one example of an environment including an integration runtime including integration runtimes that utilize cloud environment resources that are tracked by various agents.

FIG. 3 is a chart showing one example schema that may be used to describe resource usage data.

FIG. 4 is a flowchart showing one example of a process flow that may be executed in the environment of FIG. 1 and/or the environment of FIG. 2 to monitor integration flow resource usage.

FIG. 5 is a flowchart showing one example of a process flow that may be executed in the environment of FIG. 1 and/or the environment of FIG. 2 to monitor integration flow resource usage and respond to undesirable usage conditions.

FIG. 6 is a flowchart showing one example of a process flow that may be executed in the environment of FIG. 1 or in the environment of FIG. 2 to provide integration flow-specific resource usage data.

FIG. 7 is a flowchart showing one example of a process flow that may be executed, for example, in the environment of FIG. 1 and/or in the environment of FIG. 2, for example, by the integration inspect service to provide the user interface to one or more users.

FIG. 8 is a diagram showing one example of a user interface screen that may be provided to a user as part of the user interface.

FIG. 9 is a diagram showing one example of a user interface screen that may be provided to a user as part of the user interface described herein.

FIG. 10 is a block diagram showing one example of an architecture for a computing device.

FIG. 11 is a block diagram of a machine in the example form of a computer system within which instructions may be executed for causing the machine to perform any one or more of the methodologies discussed herein.

### DETAILED DESCRIPTION

An integration platform, such as the SAP Cloud Integration product available from SAP SE of Walldorf, Germany, may be configured to perform various operations to facilitate the exchange of messages between one or more sender components and one or more receiver components. For example, an integration platform may be programmed to route messages from a sender component to a receiver component. The integration platform may also be programmed to transform messages, from a format received from the sender component and to a format expected by the receiver component. In some examples, the integration platform may also manage the configurations of the sender system and/or the receiver system. For example, the integration platform may manage the sending component to configure a user account that is associated with a sent message, permissions associated with the sent message, messaging policies, and/or the like. The integration platform may also configure the receiver system, for example, by specifying endpoints for various messages, credentials to access the receiver system with the message, and/or the like.

Consider an example in which an enterprise operates a source system that generates and/or uses master data. The enterprise may wish to make the master data available to other destination systems. The enterprise may utilize the integration platform as a middleware to replicate the master data so that a new state defined by the master data is also updated on the destination systems. In some examples, an enterprise utilizes an integration platform to integrate between multiple sets of sending and receiving components. For example, an enterprise may desire to interface between software components for different tasks including, for example, different database components, different enterprise resource planning components, and/or the like. Each integration between a particular sending component or components and a particular receiving component or components may utilize a configuration that is specific to the combination of sending and receiving components.

In some examples, an integration platform may be implemented utilizing multiple integration flows. An integration flow may be an executable software component that is programmed to interface between at least one particular sender component and at least one particular receiver component. In some examples, a number of integration flows are deployed in an integration runtime. In this way, different integration flows may be individually programmable and deployable based on the needs of the enterprise utilizing the integration platform.

In some examples, the integration platform is implemented in a cloud environment, such as in a public cloud environment. A public cloud environment is arranged into a number of tenancies implemented by a cloud service provider. The cloud service provider may also provide one or more executables or other components to implement and support the integration platform at the public cloud environment, for example according to a Software as a Service (SaaS) model. Different tenancies may be held by different enterprises, with each tenancy implementing at least one instance of the integration platform, or another software solution, for the respective enterprises. In some examples, a single enterprise may hold more than one tenancy. An enterprise may hold a tenancy at the public cloud environment and utilize the integration platform executing at the tenancy to interface between different sets of sending and receiving software components.

Arranging an integration platform in a cloud environment utilizing integration flows, as described herein, can provide certain advantages. For example, the use of different integration flows may allow an enterprise to utilize a shared integration runtime to manage multiple different sets of sending and receiving components. In some examples, it may also increase the configurability and/or scalability of the integration platform. For example, an enterprise may add support for a new set of receiving and/or sending components by adding an additional integration flow to an existing integration platform or remove support for an obsolete set of receiving and/or sending components by removing the corresponding integration flow. Also, an enterprise may modify an integration between components by modifying parameters of a single integration flow instead of modifying the integration platform as a whole.

Although arranging an integration platform in a cloud environment may provide certain advantages, it also creates challenges. For example, the public cloud environment may provide various resources including hardware resources such as memory and CPU, communication resources such as network access, and storage resources such as drive space and/or database management systems. The public cloud environment may also provide one or more multi-tenant services that are callable from different tenancies.

The public cloud environment may be arranged to track resource usage by tenancy and/or by runtime. For example, the public cloud environment may track the usage of memory, database management systems, CPUs, and/or the like by tenancy. This may allow the public cloud provider to manage resource usage among tenancies. For example, if a tenancy is overusing a cloud resource, the cloud provider may reduce or throttle resource usage by that tenancy. Also, in some examples, the cloud provider may bill the enterprise holding the tenancy for increased resource usage.

Although the public cloud environment may be arranged to track resource usage by tenancy and/or by runtime, it may not be configured to discriminate resource usage between different components within a single tenancy or a single runtime. Accordingly, the public cloud environment may track resource usage by the integration platform but may not track resource usage by individual integration flow. As a result, if the integration platform is over-using cloud environment resources, it may be difficult for users associated with the enterprise to determine the particular integration flow or integration flows causing the overuse. For example, users who troubleshoot integration flows may desire to know resource usage by integration flow including, for example, the distribution or proportion of resources being consumed by different integration flows. Because the configuration of the integration platform may be modified on an integration flow-by-integration flow basis, this may complicate the enterprise's efforts to identify and address the source of the overuse.

Various examples address these and other challenges utilizing an arrangement including one or more agents executing with respective integration flows and an integration inspect service. Agents may also be implemented in the integration runtime and may be configured to track resource usage by the integration flows. For example, each integration flow may be associated with one or more respective agents to monitor its resource usage. The agents may, for example, monitor resource use requests made by an integration flow and/or otherwise monitor the resources consumed by the integration flow. The agent may provide resource usage data describing cloud environment resource usage of an integration flow to an integration inspect service. The integration inspect service may be a service executing at the cloud environment. The integration inspect service may receive resource usage data from a plurality of agents monitoring resource usage for different integration flows. The integration inspect service may utilize the resource usage data to provide integration flow-by-integration flow resource usage data.

Integration flow-by-integration flow resource usage data may be utilized in various ways. For example, the integration inspect service may generate a user interface that may be provided to one or more users associated with the relevant enterprise. The users may utilize the user interface to detect resource usage issues associated with a subset of all of the integration flows executing with a single integration runtime. This may allow the user to modify parameters of one or more integration flows that are overusing cloud environment resources and make modifications to remedy the situation.

The integration inspect service, in some examples, may also be configured to monitor the resource usage data describing the respective integration flows and provide an alert message to one or more administrative users when an integration flow is using cloud environment resources outside of one or more threshold usage conditions. This may prompt the administrative user to modify parameters of one or more of the integration flows. Also, in some examples, the integration inspect service is programmed to automatically modify a parameter or parameters of an integration flow, for example, to manage resource usage.

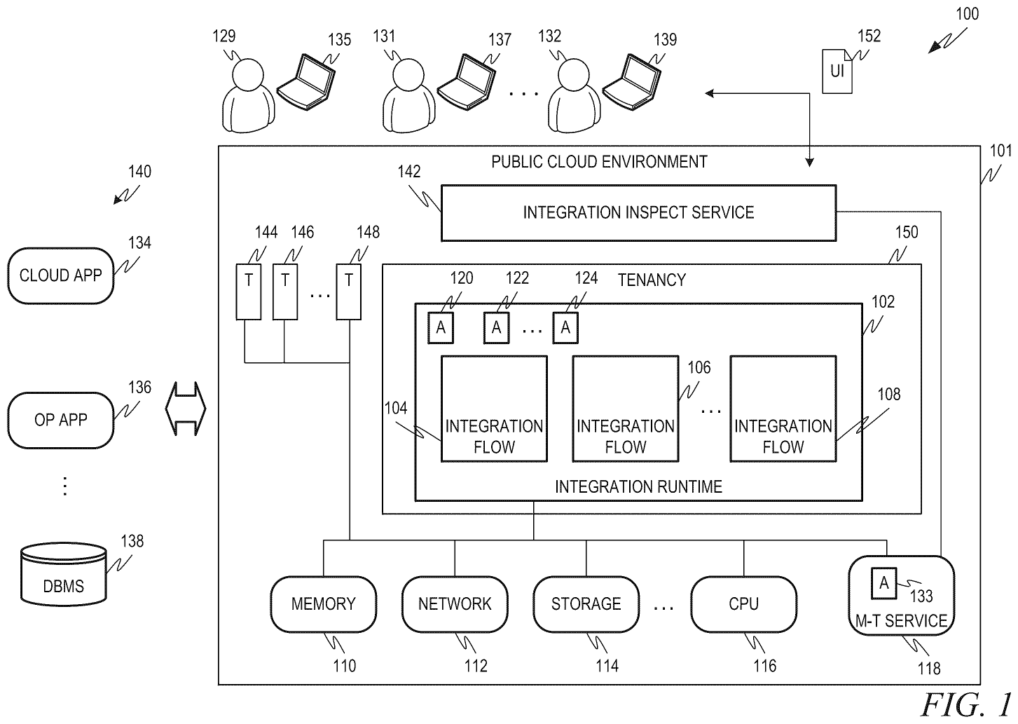

FIG. 1 is a diagram showing one example of an environment 101 managing resource usage by integration flows 104, 106, 108 in a cloud environment 101. In the example of FIG. 1, the cloud environment 101 is a public cloud environment providing an integration platform according to a SaaS format. The public cloud environment 101 may be implemented using one or more computing devices located at a common geographic location and/or distributed across multiple different geographic locations. The public cloud environment 101 comprises tenancies 144, 146, 148, 150. Each tenancy 144, 146, 148, 150 may execute one or more software applications provided to customer enterprises, for example, according to a SaaS arrangement.

The various tenancies may be accessible by users 129, 131, 132 via user computing devices 135, 137, 139. Each user 129, 131, 132 may be associated with an enterprise holding at least one of the tenancies 144, 146, 148, 150. In some examples, the public cloud environment 101 may manage authentication of the users 129, 131, 132. For example, applications executed in a tenancy 144, 146, 148, 150 may be accessible to users 129, 131, 132 associated with the enterprise holding the tenancy 144, 146, 148, 150, and may not be accessible to users associated with other enterprises. User computing devices 135, 137, 139 may be or include various different types of computing devices such as, for example, desktop computers, laptop computers, tablet computers, mobile computing devices, and/or the like.

Applications executing at the various tenancies 144, 146, 148, 150 may utilize common cloud environment resources such as, for example, memory resources 110, network resources 112, data storage resources 114, and/or CPU resources 116. Memory resources 110 may include random access memory that is accessible to various applications executing at the tenancies 144, 146, 148, 150. In some examples, the public cloud environment 101 may assign or reserve portions of the memory resources 110 for particular applications executing at one or more tenancies 144, 146, 148, 150.

Network resources 112 may include network adapters, routers, switches, and/or other network equipment that is available for use by applications executing at the tenancies 144, 146, 148, 150. For example, an integration platform executing at a tenancy may utilize network resources 112 to access sending and receiving software components 140. In some examples, network resources 112 may be described by an available bandwidth. Different applications and different tenancies 144, 146, 148, 150 may the assigned portions of the available bandwidth. The integration runtime 102 and/or one or more integration flows 104, 106, 108 may receive data describing the operations of hardware network resources. For example, the integration runtime 102 and/or one or more integration flows 104, 106, 108 may access tracking performed by an operating system of the public cloud environment 101.

Storage resources 114 may include locations where applications executing at the tenancies 144, 146, 148 can store data. In some examples, storage resources 114 may include disks or drives at one or more servers that are also executing applications associated with one or more tenancies 144, 146, 148, 150. Also, in some examples, storage resources 114 may include one or more DBMSs provided for the various tenancies. The DBMSs may execute a common server with one or more of the tenancies 144, 146, 148 or at one or more different servers.

CPU resources 116 may be provided by one or more processors at one or more servers implementing the public cloud environment 101. Access to CPU resources 116 may be described in terms of processor time, operations, and/or any other suitable measure. The memory resources 110, network resources 112, storage resources 114, in CPU resources 116 are examples of resources that may be provided to multiple tenancies 144, 146, 148, 150 in the public cloud environment 101. It will be appreciated, however, that some public cloud environments 101 may provide additional or fewer resources than are shown in FIG. 1.

FIG. 1 also shows a multitenant service 118. The multitenant service 118 may be a service provided by the public cloud environment that may be called and/or otherwise utilized by applications executing at more than one of the tenancies 144, 146, 148. Examples of multitenant services may include, for example, services to monitor or manage resources 110, 112, 114, 116. Another example multitenant service may be a scripting service that is used to compile dynamic scripts from the integration flows 104, 106, 108 (and integration flows at other tenancies) and execute the dynamic scripts to return results to the calling integration flow 104, 106, 108 (or across tenants). Yet another example multitenant service is a mapping service. A mapping service may map message formats from one schema to another and may be accessible to integration flows at different tenancies.

In various examples, applications executed at a tenancy may be arranged according to a microservice architecture. In a microservice architecture, different portions of an application are implemented by a collection of loosely-coupled microservices executing at the cloud environment. Each microservice may include an executable that executes in a container implemented by the public cloud environment 101. In a microservice architecture, each microservice is programmed to perform a defined task or small set of tasks and interact with the other microservices in a defined way, for example, according to an application programming interface (API).

In the environment 100, the tenancy 150 is shown executing an integration platform. The integration platform comprises an integration runtime 102 and example integration flows 104, 106, 108. In some examples, the integration runtime 102 and integration flows 104, 106, 108 may be implemented according to a micro-service architecture. For example, the integration runtime 102 and respective integration flows 104, 106, 108 may be implemented using a set of micro-services that may execute at a common container. Also, in some examples, the integration runtime 102 and the respective integration flows 104, 106, 108 may execute in separate containers. In some examples, the integration flows 104, 106, 108 are implemented as schemas or descriptions of how to process an inbound message from a sending system and transform the message to a message that is readable by the receiving system. The integration runtime 102 may run the one or more integration flows 104, 106, 108, for example, in response to receiving corresponding incoming messages from a sending system.

The integration platform manages messaging between two or more software components, such as example software components 140. The example software components 140 include a cloud application 134, and on-premise executed application 136, and a DBMS 138. The cloud application 134 may be executed in a cloud environment such as, a public cloud environment or a private cloud environment. In some examples, the cloud application 134 is executed at the public cloud environment 101, for example, at the tenancy 150 and/or at a different tenancy 144, 146, 148 that may be held by the same enterprise as the enterprise holding the tenancy 150. Although a single cloud application 134 is shown, it will be appreciated that an integration platform may manage messaging for more than a single cloud application.

The on-premise application 136 is executed at an on-premise computing system. For example, an enterprise utilizing the on-premise application 136 may maintain one or more servers, network equipment components, and or the like to implement the on-premise computing system. The on-premise application 136 may be implemented by executing appropriate software at the on-premise computing system.

The DBMS 138 may be implemented, for example, in a cloud environment and/or in an on-premise environment. The DBMS 138 may implement a database management system that may be associated with one or more client applications. In some examples, the DBMS 138 may be or include a database management system, such as the of S/4 HANA™, SAP Concur®, SAP Successfactors®, SAP Data Warehouse Cloud, Inbound Document (IBD), available from SAP SE of Walldorf, Germany. Other examples of cloud-delivered data sources may include SQL database services such as, for example, BigQuery® available from Google, LLC of Mountain View, California, Sharepoint® available from Microsoft Corporation of Redmond, Washington, various data storage products available from Salesforce, Inc. of San Francisco, California, and/or the like.

It will be appreciated that the software components 140 are examples of software components that can be managed by an integration platform. In many example systems, an integration platform will manage messaging between combinations of more than the three example software components 140 shown and FIG. 1. Also, it will be appreciated that the types of example software components 140 shown in FIG. 1 are provided for example purposes and are not exhaustive. Other types of applications may be managed by an integration platform.

In some examples, each integration flow 104, 106, 108 is programmed to provide message integration between two or more software components such as example software components 140. Each integration flow 104, 106, 108 may be an executable software component associated with the integration runtime 102. For example, the integration flows 104, 106, 108 may comprise one or more executable microservices that execute in a common container with the integration runtime 102 and/or in different containers. Also, in some examples, a container in which one or more of the integration flows 104, 106, 108 executes and a container in which the integration runtime 102 executes may be managed by a common container orchestration service such as, for example, a Kubernetes® container orchestration system.

Integration flows 104, 106, 108 may be configurable with parameters that control how the respective integration flows 104, 106, 108 perform integration with respect to two or more software components, such as the example software components 140. For example, an integration flow 104, 106, 108 may have a maximum message size that can be processed. Reducing the maximum message size may decrease processing resources consumed by the integration flow 104, 106, 108 while performing integration tasks.

In some examples, integration flows 104, 106, 108 have one or more configurable parameters that relate to message throttling. For example, an integration flow 104, 106, 108 may be arranged to process messages serially, that is one at a time. In other arrangements, an integration flow 104, 106, 108 may be arranged to process messages in parallel. In some examples, the volume of messages that an integration flow 104, 106, 108 can process in parallel is further configurable. For example, an integration flow 104, 106, 108 may have a maximum number of messages that can be processed at the same time. Also, in some examples, an integration flow 104, 106, 108 may delay the beginning of a new message processing task until a threshold time has passed since the beginning of the previous message processing task. In various examples, an integration flow 104, 106, 108 may be modified to change parameters such as, whether it processes messages serially or in parallel, the number of messages that may be simultaneously processed in parallel, a threshold time period for beginning a new message processing task, and/or the like. Such changes may affect the resource consumption of the integration flow. For example, fewer messages processed per unit time may correlate to lower resource usage.

In some examples, one or more integration flows 104, 106, 108 may be configurable with respect to the number of integration flow operations performed to process a message from a sender component to a receiver component. Additional integration flows operations may consume additional cloud environment resources. Accordingly, reconfiguring an integration flow 104, 106, 108 to perform fewer integration flows operations per message may reduce resource consumption at the integration flow 104, 106, 108.

In some examples, an integration flow 104, 106, 108 may be configurable with respect to the type of adapter used to interface with example software components 140. An adapter used by an integration flow 104, 106, 108 may be a type of interface and/or process used by the integration flow 104, 106, 108 to communicate with the sender software component or components and the receiver software component or components. Different adapter types may consume different levels of resources at the public cloud environment 101. For example, an adapter type that performs a validation of message syntax, such as a Simple Object Access Protocol (SOAP) may require more time and therefore consume more resources than another adapter that does not include such a validation. Accordingly, it may be possible to reduce the cloud environment resources used by an integration flow 104, 106, 108 by modifying the type of adapter used.

In some examples, one or more integration flows 104, 106, 108 may be configurable with respect to a number of external calls. An integration flow 104, 106, 108 may access other systems while processing a message. This may be performed, for example, for content look up, intermediate updates to the integration flow 104, 106, 108, and/or the like. Reducing the number of external calls may reduce the cloud environment resources consumed by the integration flow 104, 106, 108.

In some examples, one or more of the integration flows 104, 106, 108 may be configurable in its use of memory resources 110 versus database or storage resources 114. For example, read operations and write operations to a database may be replaced with faster read and write operations to a memory resource 110 if the requirements of the integration flow 104, 106, 108 allow.

Various other example parameters of an integration flow 104, 106, 108 may be configurable in a manner that affects the cloud environment resources consumed by the integration flow. These may include, the form or pagination of external system queries, whether operations are performed in series or parallel, whether authenticated communications sessions are re-used, time out thresholds for receiving messages, query responses, and the like, a maximum number of retries when an attempted communication fails, whether calls to APIs are executed as-received or in batch format, and/or the like.

The integration runtime 102 may have one or more associated agents 120, 122, 124. Agents 120, 122, 124 may be configured to collect resource usage data describing resource usage by the respective integration flows 104, 106, 108. The agents 120, 122, 124 may be further configured to periodically provide the resource usage data to an integration inspect service 142, which is configured to process the resource usage data, for example, as described herein.

The agents 120, 122, 124 may be executables that execute at the public cloud environment 101, for example, in the tenancy 150. In some examples, an agent is a micro-service that executes in a common container with the integration runtime 102.

In some examples, agents 120, 122, 124 are configured to monitor resource requests made by the respective integration flows 104, 106, 108. For example, an agent 120, 122, 124 may be configured to intercept requests to memory resources 110, network resources 112, storage resources 114, and/or CPU resources 116. The agent 120, 122, 124 may keep a record of resource requests and usage by integration flow 104, 106, 108 and may periodically provide the resulting resource usage data to the integration inspect service 142, either directly or via an intermediate storage, as described herein.

In some examples, an agent 120, 122, 124 may be configured to monitor usage of cloud environment resources of a particular type. For example, the integration runtime 102 may be associated with an agent for monitoring usage of memory resources 110, an agent for monitoring usage of network resources 112, and so on. In other examples, a single agent 120, 122, 124 may be arranged to monitor integration flow-specific usage of multiple different kinds of resources.

The integration inspect service 142 may receive and process resource usage data from the various agents 120, 122, 124. The integration inspect service 142 may be a service implemented at the public cloud environment 101, such as, an executable software component. In various examples, the integration inspect service 142 is or includes one or more micro-services executing within a container at the public cloud environment 101. In some examples, the integration inspect service 142 is a multitenant service. For example, the integration inspect service 142 may operate to track the resource usage of integration flows 104, 106, 108 executing at the tenancy 150 as well as other integration flows executing at one or more other tenancies 144, 146, 148.

The integration inspect service 142 may utilize the resource usage data generated by the respective agents 120, 122, 124 to generate a user interface 152. The user interface 152 may be a user interface comprising one or more screens or other user interface elements. The user interface 152 may be provided to one or more users 129, 131, 132 associated with the enterprise holding the tenancy 150. For example, the user interface 152 may be provided to administrative users of the enterprise. If the users 129, 131, 132 determine that the resource usage of one or more of the integration flows 104, 106, 108 is outside of a threshold usage, then the user 129, 131, 132 may modify a configuration parameter or parameters of the affected integration flow or flows 104, 106, 108.

In some examples, the integration inspect service 142 may be configured to detect when one or more of the integration flows 104, 106, 108 is consuming resources outside of a threshold usage. For example, the integration flow 104, 106, 108 may be overusing cloud environment resources. This may indicate that it is desirable to change one or more parameters of the integration flow 104, 106, 108 so as to reduce resource usage. Also, in some examples, the resource usage data may indicate that one or more of the integration flows 104, 106, 108 is under-consuming resources. This may be an indication that the integration flow 104, 106, 108 is performing erroneously. When the integration inspect service 142 determines that an integration flow 104, 106, 108 is using one or more cloud environment resources outside of a threshold usage, it may provide an alert to one or more of the users 129, 131, 132, for example, via the user interface 152. In some examples, the integration inspect service 142 is configured to automatically modify one or more parameters of an integration flow 104, 106, 108 if that integration flow 104, 106, 108 is found to be consuming cloud environment parameters outside of the threshold usage.

In the example environment 100 of FIG. 1, the multitenant service 118 also has an associated agent 133. The agent 133 of the multitenant service 118 is configured to track usage of the multitenant service 118 by the respective integration flows 104, 106, 108. For example, when one of the integration flows 104, 106, 108 calls the multitenant service 118, the agent 133 may intercept the call and store resource usage data describing the call and/or the integration flow 104, 106, 108 making the call. The agent 133 may be programmed to provide stored resource usage data to the integration inspect service 142. The integration inspect service may also consider resource usage data generated by agents associated with multitenant services, such as the agent 133.

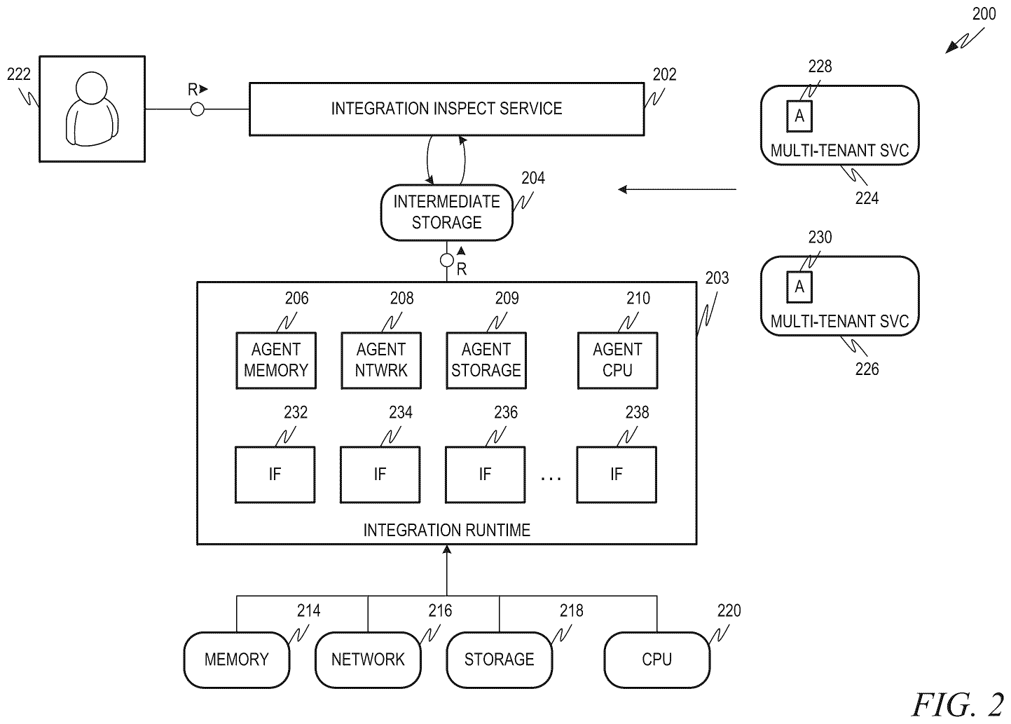

FIG. 2 is a diagram showing one example of an environment 200 including an integration runtime 203 running integration flows 232, 234, 236, 238 that utilize cloud environment resources that are tracked by various agents, as described herein. The environments 200 may be executed in a cloud environment, for example, similar to the public cloud environment 100 of FIG. 1. In some examples, the integration runtime 203 may be executed within a tenancy at the cloud environment. Various resources 214, 216, 218, 220 and multitenant services 224, 226 may be available to integration flows 232, 234, 236, 238 being run by the integration runtime 203, and to other applications executing at other tenancies of the cloud environment.

The integration runtime 203 may be part of an integration platform, for example, as described with respect to FIG. 1. The integration runtime 203 may be associated with agents 206, 208, 209, 210. In this example, a memory agent 206 monitors requests by the integration flows 232, 234, 236, 238 to a memory resource. A network agent 208 monitors requests by the integration flows 232, 234, 236, 238 for use of network resources 216. A storage agent 209 monitors requests by the integration flows 232, 234, 236, 238 for storage resources 218. A CPU agent 210 monitors requests by the integration flows 232, 234, 236, 238 for CPU resources 220. FIG. 2 also shows two example multitenant services 224, 226 that execute at the cloud environment. In this example, each of the two example multitenant services 224, 226 is associated with a respective agent 228, 230. The agents 228, 230 monitor requests directed to the multitenant services 224, 226 by the integration flows 232, 234, 236, 238 and by other integration flows executing at the cloud environment, for example, in conjunction with other integration runtime's executing at other tenancies. Although distinct agents 206, 208, 209, 210 are illustrated corresponding to specific resources 214, 216, 218, 220, in some examples, a single agent may monitor usage of multiple different resources and/or multiple different resource types.

The respective agents 206, 208, 209, 210, 228, 230 are configured to gather resource usage data and periodically provide the resource usage data to an intermediate storage 204. The intermediate storage 204 may be any suitable storage component such as, for example, a database management system, a drive resource, and/or the like. In some examples, the intermediate storage 204 is implemented as a service at the cloud environment. The integration inspect service 202 may access resource usage data from the intermediate storage 204 and provide the resource usage data to an example user 222, for example, as described herein via a user interface. The integration inspect service 202, similar to the integration inspect service 142, may also provide various alerts and/or automatic parameter changes to the integration runtime 203 based on the resource usage data.

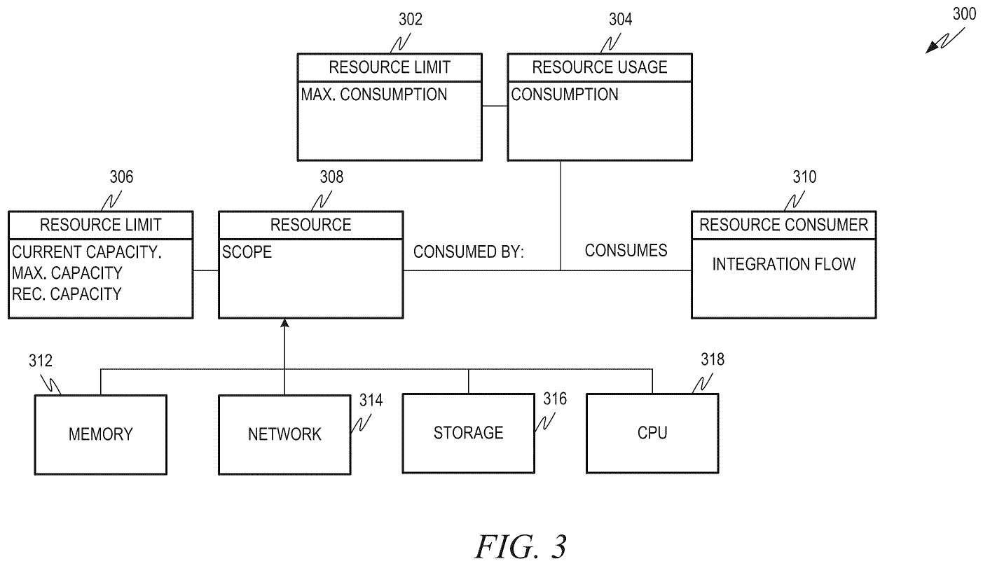

FIG. 3 is a chart showing one example schema 300 that may be used to describe resource usage data. For example, the schema 300 describes one arrangement of data that may be stored at the intermediate storage 204 and/or otherwise provided to an integration inspect service, such as the integration inspect service 142 and/or the integration inspect service 202.

The schema 300 comprises a resource consumer 310 that consumes a resource 308. The resource consumer 310 may be an entity that consumes a resource such as, for example, an integration flow. In some examples, the resource consumer 310 may be and other resource such as, for example, a database management system.

The resource 308 consumed by the resource consumer 310 may be any suitable resource described herein such as, for example, a memory resource 312, a network resource 314, a storage resource 316, a CPU resource 318, and/or the like. The resource 308 may be described by a resource limit 306. The resource limit 306 may indicate one or more limits on the quantity of one or more resources that may be provided to all resource consumers including the resource consumer 310.

In some examples, the resource 308 provided to the resource consumer 310 may be described by resource consumer-specific data such as, resource usage data 304 and resource limit data 302. The resource usage data 304 may describe a current usage of the resource 308 by the resource consumer 310. The resource limit data 302 may indicate one or more limits on the usage of one or more resources by the resource consumer 310.

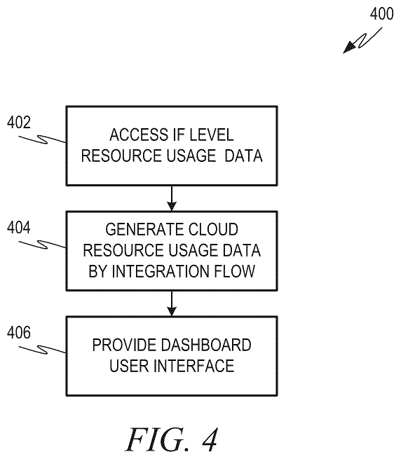

FIG. 4 is a flowchart showing one example of a process flow 400 that may be executed, for example, in the environment 100 of FIG. 1 and/or the environment 200 of FIG. 2 to monitor integration flow resource usage. The process flow 400 may be performed, for example, by an integration inspect service or other suitable software component at a cloud environment. At operation 402, the integration inspect service may access integration flow level resource usage data. The integration flow level resource usage data may have been generated by one or more agents, as described herein. In some examples, the integration inspect service receives the integration flow level resource usage data directly from one or more agents. In some examples, the integration inspect service accesses the resource usage data from an intermediate data store, for example, as described herein with respect to FIG. 2.

At operation 404, the integration inspect service generates cloud resource usage data by integration flow. For example, the integration inspect service may access integration flow-level resource usage data for a tenancy. The integration inspect service is configured to utilize the integration flow-level resource usage data to assign resource usage indicated on the tenancy level to particular integration flows. At operation 406, the integration inspect service is configured to provide a user interface to one or more users. The user interface may include the cloud resource usage data arranged by integration flow.

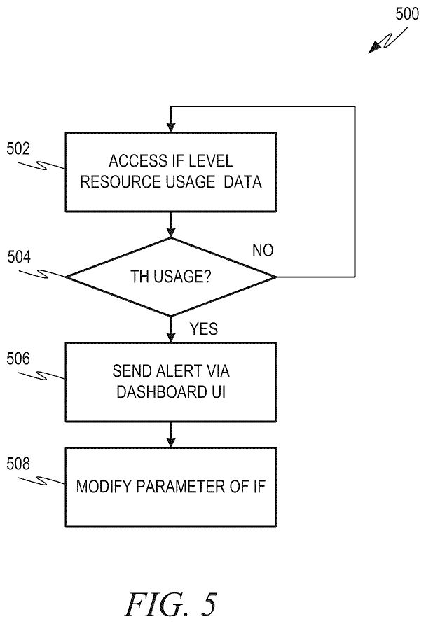

FIG. 5 is a flowchart showing one example of a process flow 500 that may be executed, for example, in the environment 100 of FIG. 1 and/or the environment 200 of FIG. 2 to monitor integration flow resource usage and respond to undesirable usage conditions. The process flow 500 may be performed, for example, by an integration inspect service or other suitable software component at a cloud environment. At operation 502, the integration inspect service may access integration flow level resource usage data generated by one or more agents, for example, as described herein. At operation 504, the integration inspect service may determine if the resource usage data indicates that any integration flows are using cloud environment resources in a way that does not meet a threshold usage.

In some examples, the integration inspect service 142 may apply different threshold usage levels to different cloud environment resources. For example, an integration flow may be determined to consume memory resources outside of a threshold usage if it makes more than a threshold number of read or write requests in a given time period and/or if it consumes more than a threshold amount of memory. An integration flow may be determined to consume network resources outside of a threshold usage if it sends more than a threshold number and/or size of messages using the network resources in a given time period. An integration flow may be determined to consume storage resources outside of a threshold usage if it, for example, makes more than a threshold number of read and/or write requests to storage resources and/or if it consumes more than a threshold amount of storage. An integration flow may be determined to consume CPU resources outside of a threshold usage if it, for example, consumes more than a threshold percentage of CPU time, more than a threshold number of CPU operations, and/or the like.

If no integration flows are consuming cloud environment resources greater than a threshold usage, the integration inspect service 142 may continue to access next integration flow level resource usage data at operation 502. If one or more integration flows are consuming cloud environment resources outside a threshold level, the integration inspect service may, at operation 506, send an alert to one or more users of the corresponding enterprise. The alert may indicate the integration flow or integration flows that are consuming cloud environment resources outside of the threshold level along with the cloud resource or resources that are being consumed outside of the threshold usage. The alert may be, for example, a user interface screen, an email, a messaging service message, and/or the like.

In addition to or instead of sending the alert at operation 506, the integration inspect service 142 may, at operation 508, modify one or more parameters of the integration flow that is consuming cloud resources outside of the threshold usage this may include modifying one or more parameters in a way that reduces the resource usage of the integration flow. In some examples, the integration inspect service may both send the alert at operation 506 and modify the parameters of the integration flow or flows at operation 508. Modifying the parameters of the integration flow or flows may ameliorate the resource overuse, while the alert may provide the user with an indication that a more considered modification to integration flow parameters may be desirable.

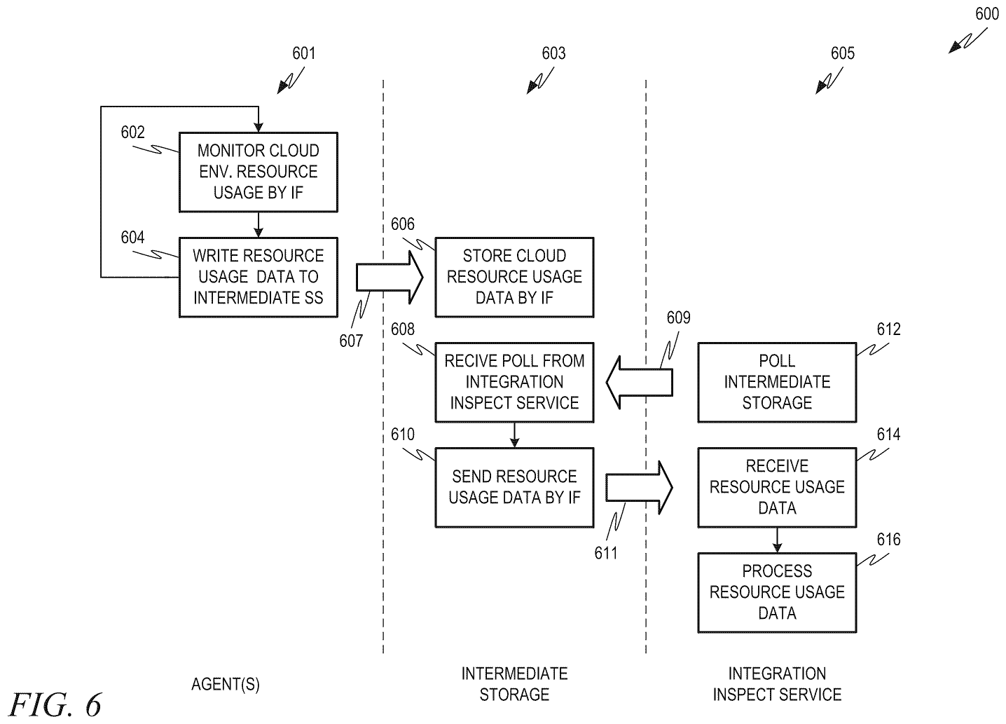

FIG. 6 is a flowchart showing one example of a process flow 600 that may be executed, for example, in the environment 100 of FIG. 1 or in the environment 200 of FIG. 2 to provide integration flow-specific resource usage data. The process flow 600 comprises three columns 601, 603, 605. The column 601 shows operations performed by an agent, such as one of the agents 120, 122, 124, 133, 206, 208, 209, 210, 228, 230. It will be appreciated that the operations in column 601 may be performed by various different agents in parallel. The column 603 includes operations performed by an intermediate storage, such as the intermediate storage 204. The column 605 includes operations performed by an integration inspect service such as, for example, the integration inspect service 142 or the integration inspect service 202.

At operation 602, the agent may monitor cloud environment resource usage by an integration flow. This may include monitoring requests made by the integration flow for various cloud environment resources. The duration of time over which the agent monitors cloud environment resource usage by an integration flow or flows may be configurable. For example, an agent may be configured to monitor an integration flow or flows for a predetermined amount of time before writing the results to the intermediate storage and or otherwise providing the results to the integration inspect service. At operation 604, the agent may write resource usage data 607 describing the cloud environment resource usage of the integration flow to the intermediate storage. The intermediate storage may store the resource usage data at operation 606. In some examples, the agent is programmed to perform the operation 604 periodically, such as, for example, every 30 minutes, every hour, every five hours, every 15 hours, every 24 hours, every 30 hours, and/or the like.

At operation 612, the integration inspect service may send a poll request 609 to the intermediate storage to poll of the intermediate storage for integration flow resource usage data. The integration inspect service may be configured to poll the intermediate storage periodically, such as for example, every hour, every 12 hours, every 24 hours, every 48 hours, and/or the like. At operation 608, the intermediate storage may receive the poll request 609. At operation 610, the intermediate storage may send requested resource usage data 611 to the integration inspect service. The requested resource usage data 611 may include resource usage data captured by one or more agents and describing one or more integration flows. Integration inspect service may receive the resource usage data 611 at operation 614. At operation 616, the integration inspect service may process the resource usage data as described herein, including, with respect to the process flow 500.

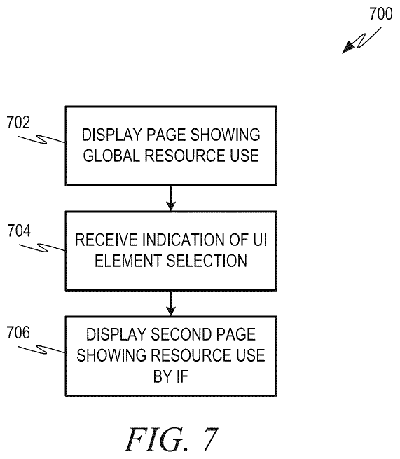

FIG. 7 is a flowchart showing one example of a process flow 700 that may be executed, for example, in the environment 100 of FIG. 1 and/or in the environment 200 of FIG. 2, for example, by the integration inspect service to provide the user interface to one or more users. At operation 702, the integration inspect service may serve to a user a first user interface page showing global resource use. The global resource use may describe usage of one or more cloud environment resources by an integration runtime and/or a tenancy as a whole. For example, the data described by the page served at operation 702 may describe usage of a single cloud environment resource and/or multiple cloud environment resources. The page may also comprise a user interface element such as, a button, checkbox, or other suitable element. The element may be selected by a user to modify or replace the screen to display data at an integration flow level.

At operation 704, the integration inspect service may receive an indication that the user has selected the user interface element. At operation 706, the integration inspect service may serve a second user interface page showing cloud environment resource usage of one or more integration flows. The serving of the second page may be in response to the selection of the user interface element. The second page may show integration flow usage of a single cloud environment resource and/or of multiple cloud environment resources. Also, in some examples, the second page may include information specific to a single integration flow and/or may include information describing resource usage by multiple different integration flows.

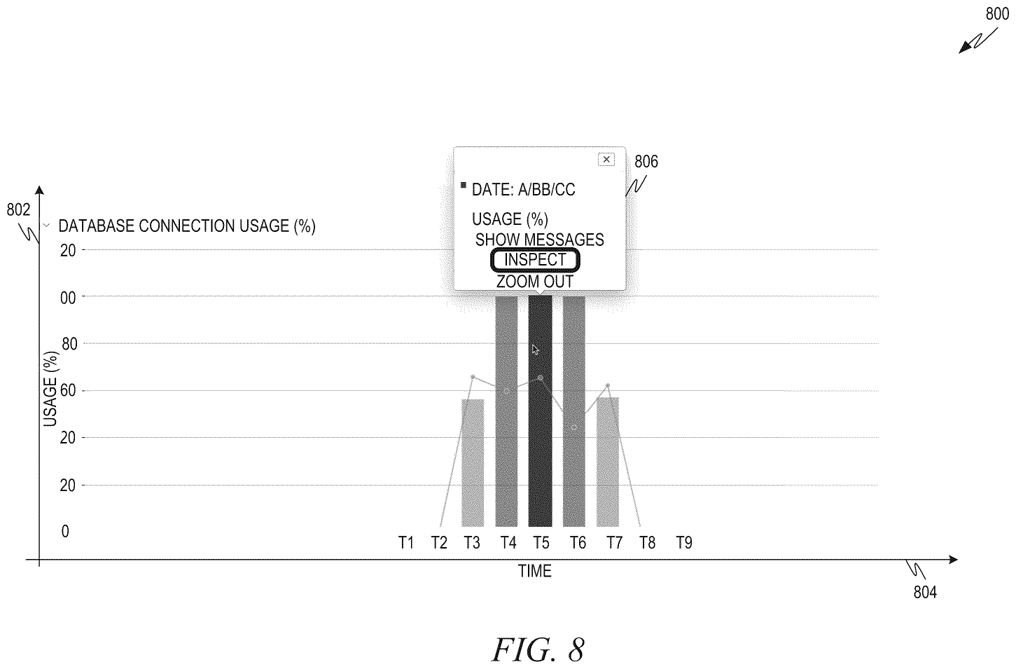

FIG. 8 is a diagram showing one example of a user interface screen 800 that may be provided to a user as part of the user interface described herein. The screen 800 describes global cloud environment resource usage. In this example, the screen 800 describes global use of a database resource. The screen 800 is one example of a screen that may be provided to a user at operation 702 of the process flow 700.

The screen 800 comprises a horizontal axis 804 indicating time in a vertical axis 802 indicating a usage percentage. The usage percentage may describe a percentage or portion of a database resource that is being used globally, e.g. by an integration runtime and/or by all components at a particular tenancy. In this example, the database connection usage is high during the time periods identified as T4, T5, and T6. The user may select the indicators, for example, at T4, T5, or T6 to cause window 806 to display. The window 806 may comprise data about the selected time period such as, the date associated with a time period, and a usage percentage associated with the time period.

The window 806 may also include menu items that are selectable by the user. In this example, the window 806 includes menu items labeled “SHOW MESSAGES,” “INSPECT,” and “ZOOM OUT.” If the user selects the menu item labeled “MESSAGES,” then the integration inspect service display an additional screen and or modify the screen 800 to display data describing messages that were processed by one or more of the integration flows in the relevant time period. If the user selects the menu item “ZOOM OUT,” then the integration inspect service may modify the screen 800 so as to provide a view of additional time periods. If the user selects the menu item labeled “INSPECT,” then the integration inspect service may display a second screen providing integration flow specific usage data describing the relevant metric.

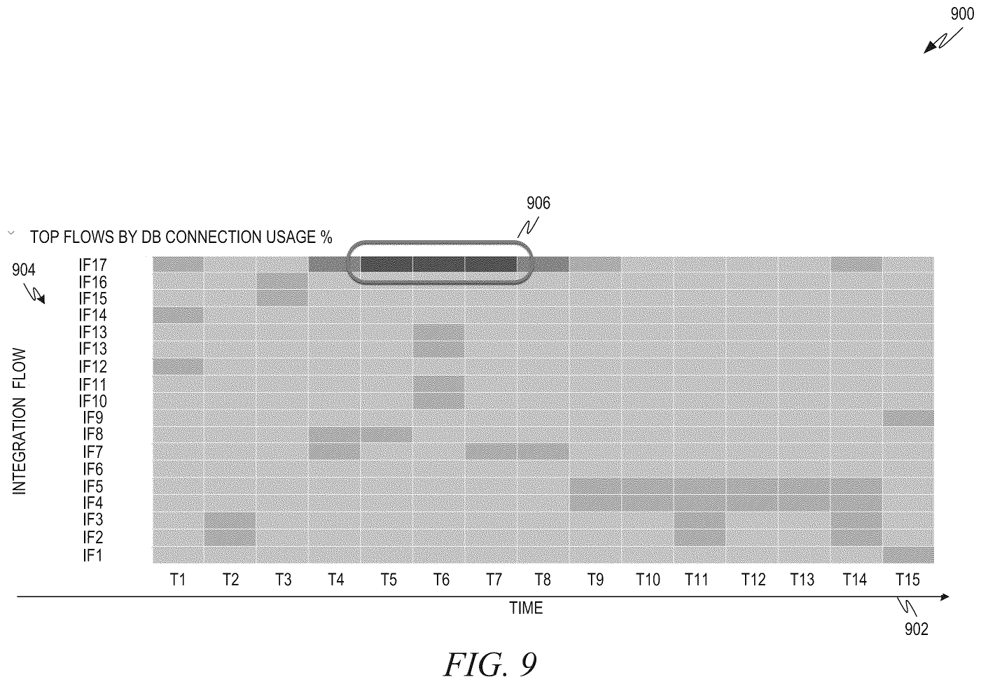

FIG. 9 is a diagram showing one example of a user interface screen 900 that may be provided to a user as part of the user interface described herein. The screen 900 describes global cloud environment resource usage. In this example, the screen 900 describes integration flow specific use of a database resource. The screen 900 is one example of a screen that may be provided to a user at operation 706 of the process flow 700.

The screen 900 indicates time in the direction of arrow 902. Integration flows IF1 through IF17 are shown at 904. The database usage connection by individual integration flow is shown by the color or shading of boxes corresponding to an integration flow and a time period. In this example, the screen 900 indicates that the integration flow IF17 had a high database connection usage percentage during time periods T5, T6, and T7. In some examples, the integration inspect service 142 is configured to modify the screen 900 to indicate times when a particular integration flow was over using cloud resources. In this example, the screen 900 includes indicator 906 pointing out the database connection usage percentage of the integration flow IF17 during the time periods T5, T6, and T7. Note that this corresponds to the global high database connection usage percentage indicated by the screen 800 at time periods T5, T6, and T7. The screen 900 may indicate to the user that it may be desirable to modify at least one perimeter of the integration flow IF17 to reduce its usage of the database resource described by FIGS. 8 and 9.

### EXAMPLES

Example 1 is an integration platform system comprising: at least one computing device implementing a cloud environment, the at least one computing system being programmed to execute: an integration runtime, the integration runtime being configured to run a plurality of integration flows associated with a first tenancy at the cloud environment, a first integration flow of the plurality of integration flows configured to interface at least one message between a first software component and a second software component; a first agent associated with the integration runtime, the first agent being programmed to monitor usage of a first cloud environment resource by at least one integration flow of the plurality of integration flows; and an integration inspect service, the integration inspect service being programmed to perform operations comprising: accessing first resource usage data generated by the first agent and describing use of the first cloud environment resource by the first integration flow; and serving, to a user computing device, a user interface based at least in part on the first resource usage data.

In Example 2, the subject matter of Example 1 optionally includes the at least one computing device being further programmed to execute a second agent associated with the integration runtime, the second agent being programmed to monitor usage of a second cloud environment resource by the at least one integration flow of the plurality of integration flows, the user interface also being based at least in part on second resource usage data generated by the second agent.

In Example 3, the subject matter of any one or more of Examples 1-2 optionally includes the at least one computing system being further programmed to execute: a multitenant service, the multitenant service being programmed to provide a service to at least one executable at the first tenancy and at least one executable at a second tenancy at the cloud environment; and a multitenant service agent, the multitenant service agent being programmed to monitor usage of the multitenant service by at least one integration flow of the plurality of integration flows.

In Example 4, the subject matter of Example 3 optionally includes the integration inspect service being further programmed to perform operations comprising accessing multitenant service resource usage data generated by the multitenant service agent and describing use of the multitenant service by the at least one integration flow of the plurality of integration flows, the user interface also being based at least in part on the multitenant service resource usage data.

In Example 5, the subject matter of any one or more of Examples 1-4 optionally includes the first agent being programmed to perform operations comprising writing the first resource usage data to an intermediate storage at the cloud environment, and the integration inspect service being further programmed to perform operations comprising accessing the first resource usage data from the intermediate storage.

In Example 6, the subject matter of any one or more of Examples 1-5 optionally includes the integration inspect service being further programmed to perform operations comprising: determining that the first resource usage data describes use of the first cloud environment resource by the first integration flow that does not meet a threshold usage; and sending, via the user interface, an alert to the user computing device, the alert describing at least one of the first cloud environment resource and the first integration flow.

In Example 7, the subject matter of any one or more of Examples 1-6 optionally includes the integration inspect service being further programmed to perform operations comprising: determining that the first resource usage data describes use of the first cloud environment resource by the first integration flow that does not meet a threshold usage; and responsive to determining that the first resource usage data describes use of the first cloud environment resource by the first integration flow that does not meet a threshold usage, modifying, at least one parameter of the first integration flow.

In Example 8, the subject matter of any one or more of Examples 1-7 optionally includes the integration inspect service being further programmed to perform operations comprising: providing, via the user interface, a first screen displaying usage of first cloud environment resource during a first time period, the first screen comprising a user interface element; receiving, an indication that the user interface element has been selected; and responsive to the indication that the user interface element has been selected, providing, via the user interface, a second screen displaying usage of the first cloud environment resource by the first integration flow over the first time period and usage of the first cloud environment resource by a second integration flow over the first time period.

In Example 9, the subject matter of any one or more of Examples 1-8 optionally includes the first cloud environment resource being at least one of a memory resource, a network resource, a database resource, and a central processing unit (CPU) resource.

Example 10 is a method for executing an integration platform, comprising: interfacing between a first software component and a second software component, the interfacing being performed by a first integration flow of a plurality of integration flows run by an integration runtime executing at a first tenancy at a cloud environment; monitoring, by a first agent associated with the integration runtime, usage of a first cloud environment resource by at least one integration flow of the plurality of integration flows; accessing, by an integration inspect service, first resource usage data generated by the first agent and describing use of the first cloud environment resource by the first integration flow; and serving, by an integration inspect service and to a user computing device, a user interface based at least in part on the first resource usage data.

In Example 11, the subject matter of Example 10 optionally includes monitoring, by a second agent associated with the integration runtime, usage of a second cloud environment resource by the at least one integration flow of the plurality of integration flows, the user interface also being based at least in part on second resource usage data generated by the second agent.

In Example 12, the subject matter of any one or more of Examples 10-11 optionally includes monitoring resource usage of a multitenant service, by a multitenant service agent executing at the cloud environment, the multitenant service being programmed to provide a service to at least one executable at the first tenancy and at least one executable at a second tenancy at the cloud environment.

In Example 13, the subject matter of Example 12 optionally includes accessing, by the integration inspect service, multitenant service resource usage data, the multitenant service resource usage data being generated by the multitenant service agent and describing use of the multitenant service by at least one integration flow of the plurality of integration flows, the user interface also being based at least in part on the multitenant service resource usage data.

In Example 14, the subject matter of any one or more of Examples 10-13 optionally includes writing, by the first agent, the first resource usage data to an intermediate storage; and accessing, by the integration inspect service, the first resource usage data from the intermediate storage.

In Example 15, the subject matter of any one or more of Examples 10-14 optionally includes the integration inspect service being further programmed to perform operations comprising: determining, by the integration inspect service, that the first resource usage data describes use of the first cloud environment resource by the first integration flow that does not meet a threshold usage; and sending, via the user interface, an alert to the user computing device, the alert describing at least one of the first cloud environment resource and the first integration flow.

In Example 16, the subject matter of any one or more of Examples 10-15 optionally includes determining, by the integration inspect service, that the first resource usage data describes use of the first cloud environment resource by the first integration flow that does not meet a threshold usage; and responsive to determining that the first resource usage data describes use of the first cloud environment resource by the first integration flow that does not meet a threshold usage, modifying at least one parameter of the first integration flow.

In Example 17, the subject matter of any one or more of Examples 10-16 optionally includes providing, by the integration inspect service and via the user interface, a first screen displaying usage of first cloud environment resource during a first time period, the first screen comprising a user interface element; receiving, by the integration inspect service, an indication that the user interface element has been selected; and responsive to the indication that the user interface element has been selected, providing, by the integration inspect service and via the user interface, a second screen displaying usage of the first cloud environment resource by the first integration flow over the first time period and usage of the first cloud environment resource by a second integration flow over the first time period.

In Example 18, the subject matter of any one or more of Examples 10-17 optionally includes the first cloud environment resource being at least one of a memory resource, a network resource, a database resource, and a central processing unit (CPU) resource.

Example 19 is a non-transitory machine-readable medium comprising instructions that, when executed by at least one processor, because the at least one processor to perform operations comprising: interfacing between a first software component and a second software component, the interfacing being performed by a first integration flow of a plurality of integration flows run by an integration runtime executing at a first tenancy at a cloud environment; monitoring, by a first agent associated with the integration runtime, usage of a first cloud environment resource by at least one integration flow of the plurality of integration flows; accessing, by an integration inspect service, first resource usage data generated by the first agent and describing use of the first cloud environment resource by the first integration flow; and serving, by an integration inspect service and to a user computing device, a user interface based at least in part on the first resource usage data.

In Example 20, the subject matter of Example 19 optionally includes the operations further comprising monitoring resource usage of a multitenant service, by a multitenant service agent executing at the cloud environment, the multitenant service being programmed to provide a service to at least one executable at the first tenancy and at least one executable at a second tenancy at the cloud environment.

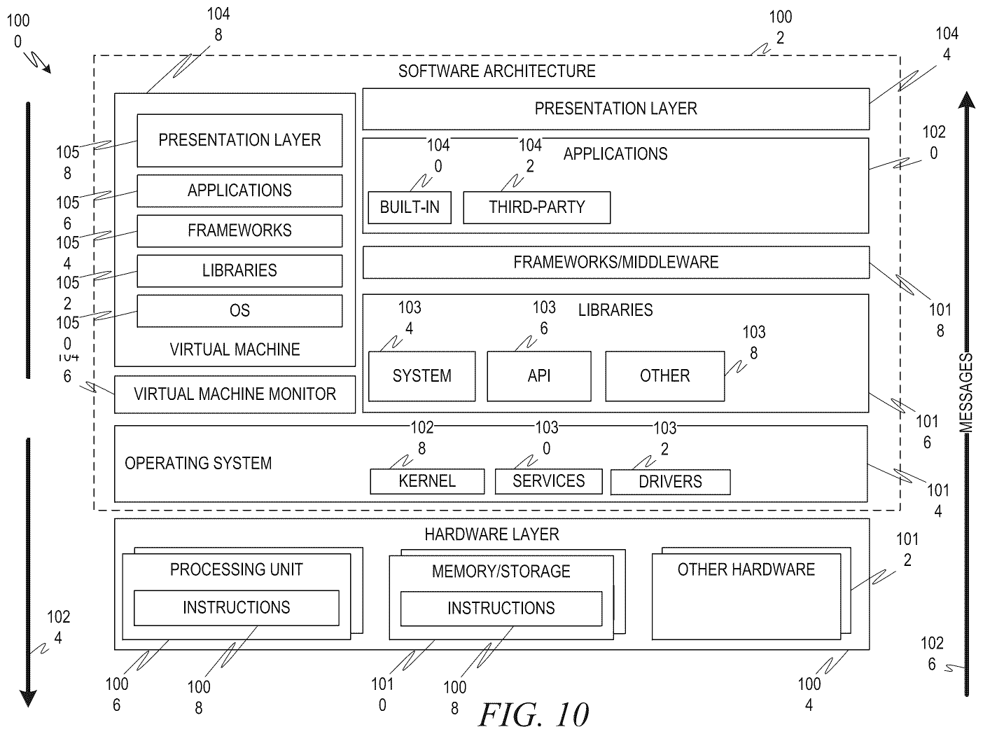

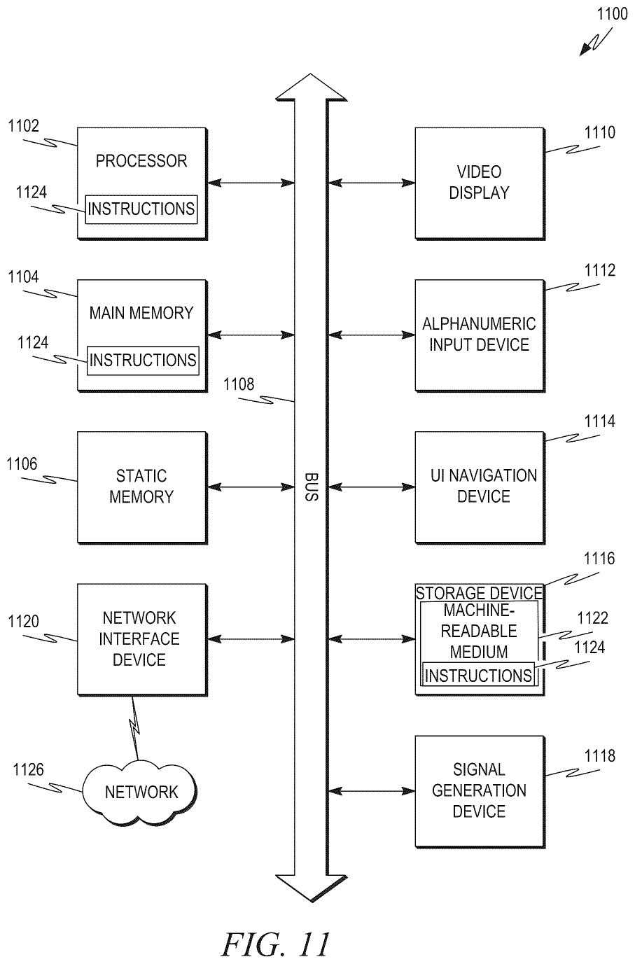

FIG. 10 is a block diagram 1000 showing one example of a software architecture 1002 for a computing device. The architecture 1002 may be used in conjunction with various hardware architectures, for example, as described herein. FIG. 10 is merely a non-limiting example of a software architecture and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 11.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 which represents any other hardware of the hardware layer 1004, such as the other hardware illustrated as part of the architecture 1002.

In the example architecture of FIG. 10, the software architecture 1002 may be conceptualized as a stack of layers where each layer provides particular functionality. For example, the software architecture 1002 may include layers such as an operating system 1014, libraries 1016, middleware layer 1018, applications 1020, and presentation layer 1044. Operationally, the applications 1020 and/or other components within the layers may invoke API calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system 1034 libraries (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The middleware layer 1018 (also sometimes referred to as frameworks) may provide a higher-level common infrastructure that may be utilized by the applications 1020 and/or other software components/modules. For example, the middleware layer 1018 may provide various graphic user interface (GUI) functions, high-level resource management, high-level location services, and so forth. The middleware layer 1018 may provide a broad spectrum of other APIs that may be utilized by the applications 1020 and/or other software components/modules, some of which may be specific to a particular operating system or platform.

The applications 1020 includes built-in applications 1040 and/or third-party applications 1042. Examples of representative built-in applications 1040 may include, but are not limited to, a contacts application, a browser application, a book reader application, a location application, a media application, a messaging application, and/or a game application. Third-party applications 1042 may include any of the built-in applications 1040 as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built-in operating system functions (e.g., kernel 1028, services 1030 and/or drivers 1032), libraries (e.g., system 1034, API libraries 1036, and other libraries 1038), and middleware layer 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine as well as the interface with the host operating system (i.e., operating system 1014). A software architecture executes within the virtual machine such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of a machine in the example form of a computer system 1100 within which instructions 1124 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (or cursor control) device 1114 (e.g., a mouse), a disk drive unit 1116, a signal generation device 1118 (e.g., a speaker), and a network interface device 1120.

### Machine-Readable Medium

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media 1122.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1124 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An integration platform system comprising:
at least one computing device implementing a cloud environment, the at least one computing system being programmed to execute:
an integration runtime, the integration runtime being configured to run a plurality of integration flows associated with a first tenancy at the cloud environment, a first integration flow of the plurality of integration flows configured to interface at least one message between a first software component and a second software component;
a first agent associated with the integration runtime, the first agent being programmed to monitor usage of a first cloud environment resource by at least one integration flow of the plurality of integration flows; and
an integration inspect service, the integration inspect service being programmed to perform operations comprising:
accessing first resource usage data generated by the first agent and describing use of the first cloud environment resource by the first integration flow; and
serving, to a user computing device, a user interface based at least in part on the first resource usage data.

2. The integration platform system of claim 1, the at least one computing device being further programmed to execute a second agent associated with the integration runtime, the second agent being programmed to monitor usage of a second cloud environment resource by the at least one integration flow of the plurality of integration flows, the user interface also being based at least in part on second resource usage data generated by the second agent.

3. The integration platform system of claim 1, the at least one computing system being further programmed to execute:
a multitenant service, the multitenant service being programmed to provide a service to at least one executable at the first tenancy and at least one executable at a second tenancy at the cloud environment; and
a multitenant service agent, the multitenant service agent being programmed to monitor usage of the multitenant service by at least one integration flow of the plurality of integration flows.

4. The integration platform system of claim 3, the integration inspect service being further programmed to perform operations comprising accessing multitenant service resource usage data generated by the multitenant service agent and describing use of the multitenant service by the at least one integration flow of the plurality of integration flows, the user interface also being based at least in part on the multitenant service resource usage data.

5. The integration platform system of claim 1, the first agent being programmed to perform operations comprising writing the first resource usage data to an intermediate storage at the cloud environment, and the integration inspect service being further programmed to perform operations comprising accessing the first resource usage data from the intermediate storage.

6. The integration platform system of claim 1, the integration inspect service being further programmed to perform operations comprising:
determining that the first resource usage data describes use of the first cloud environment resource by the first integration flow that does not meet a threshold usage; and
sending, via the user interface, an alert to the user computing device, the alert describing at least one of the first cloud environment resource and the first integration flow.

7. The integration platform system of claim 1, the integration inspect service being further programmed to perform operations comprising:
determining that the first resource usage data describes use of the first cloud environment resource by the first integration flow that does not meet a threshold usage; and
responsive to determining that the first resource usage data describes use of the first cloud environment resource by the first integration flow that does not meet a threshold usage, modifying, at least one parameter of the first integration flow.

8. The integration platform system of claim 1, the integration inspect service being further programmed to perform operations comprising:
providing, via the user interface, a first screen displaying usage of first cloud environment resource during a first time period, the first screen comprising a user interface element;
receiving, an indication that the user interface element has been selected; and
responsive to the indication that the user interface element has been selected, providing, via the user interface, a second screen displaying usage of the first cloud environment resource by the first integration flow over the first time period and usage of the first cloud environment resource by a second integration flow over the first time period.

9. The integration platform system of claim 1, the first cloud environment resource being at least one of a memory resource, a network resource, a database resource, and a central processing unit (CPU) resource.

10. A method for executing an integration platform, comprising:
interfacing between a first software component and a second software component, the interfacing being performed by a first integration flow of a plurality of integration flows run by an integration runtime executing at a first tenancy at a cloud environment;
monitoring, by a first agent associated with the integration runtime, usage of a first cloud environment resource by at least one integration flow of the plurality of integration flows;
accessing, by an integration inspect service, first resource usage data generated by the first agent and describing use of the first cloud environment resource by the first integration flow;
and
serving, by an integration inspect service and to a user computing device, a user interface based at least in part on the first resource usage data.

11. The method of claim 10, further comprising monitoring, by a second agent associated with the integration runtime, usage of a second cloud environment resource by the at least one integration flow of the plurality of integration flows, the user interface also being based at least in part on second resource usage data generated by the second agent.

12. The method of claim 10, further comprising monitoring resource usage of a multitenant service, by a multitenant service agent executing at the cloud environment, the multitenant service being programmed to provide a service to at least one executable at the first tenancy and at least one executable at a second tenancy at the cloud environment.

13. The method of claim 12, further comprising accessing, by the integration inspect service, multitenant service resource usage data, the multitenant service resource usage data being generated by the multitenant service agent and describing use of the multitenant service by at least one integration flow of the plurality of integration flows, the user interface also being based at least in part on the multitenant service resource usage data.

14. The method of claim 10, further comprising:
writing, by the first agent, the first resource usage data to an intermediate storage; and
accessing, by the integration inspect service, the first resource usage data from the intermediate storage.

15. The method of claim 10, the integration inspect service being further programmed to perform operations comprising:
determining, by the integration inspect service, that the first resource usage data describes use of the first cloud environment resource by the first integration flow that does not meet a threshold usage; and
sending, via the user interface, an alert to the user computing device, the alert describing at least one of the first cloud environment resource and the first integration flow.

16. The method of claim 10, further comprising:
determining, by the integration inspect service, that the first resource usage data describes use of the first cloud environment resource by the first integration flow that does not meet a threshold usage; and
responsive to determining that the first resource usage data describes use of the first cloud environment resource by the first integration flow that does not meet a threshold usage, modifying at least one parameter of the first integration flow.

17. The method of claim 10, further comprising:
providing, by the integration inspect service and via the user interface, a first screen displaying usage of first cloud environment resource during a first time period, the first screen comprising a user interface element;
receiving, by the integration inspect service, an indication that the user interface element has been selected; and
responsive to the indication that the user interface element has been selected, providing, by the integration inspect service and via the user interface, a second screen displaying usage of the first cloud environment resource by the first integration flow over the first time period and usage of the first cloud environment resource by a second integration flow over the first time period.

18. The method of claim 10, the first cloud environment resource being at least one of a memory resource, a network resource, a database resource, and a central processing unit (CPU) resource.

19. A non-transitory machine-readable medium comprising instructions that, when executed by at least one processor, because the at least one processor to perform operations comprising:
interfacing between a first software component and a second software component, the interfacing being performed by a first integration flow of a plurality of integration flows run by an integration runtime executing at a first tenancy at a cloud environment;
monitoring, by a first agent associated with the integration runtime, usage of a first cloud environment resource by at least one integration flow of the plurality of integration flows;
accessing, by an integration inspect service, first resource usage data generated by the first agent and describing use of the first cloud environment resource by the first integration flow;
and
serving, by an integration inspect service and to a user computing device, a user interface based at least in part on the first resource usage data.

20. The non-transitory machine-readable medium of claim 19, the operations further comprising monitoring resource usage of a multitenant service, by a multitenant service agent executing at the cloud environment, the multitenant service being programmed to provide a service to at least one executable at the first tenancy and at least one executable at a second tenancy at the cloud environment.
